(19) United States
(12) Patent Application Publication
(10) Pub. No.: US 2017/0231194 A1
(43) Pub. Date: Aug. 17, 2017

(54) LOW-PROFILE EQUINE OVERREACH BOOT

(71) Applicant: PRO EQUINE GROUP, INC., Deerfield, IL (US)

(72) Inventor: Stephen Coder, Godley, TX (US)

(21) Appl. No.: 15/432,639

(22) Filed: Feb. 14, 2017

Related U.S. Application Data
(60) Provisional application No. 62/295,241, filed on Feb. 15, 2016.

(51) Int. Cl. A01K 13/00

(52) U.S. Cl. CPC A01K 13/007

(57) ABSTRACT

An improved overreach boot for horse's lower legs is disclosed herein. In embodiments of the disclosed improved overreach boot, the boot has a shape that is winged by virtue of two concave indentations, such that when mounted to the leg of a horse, relatively little of the bottom surface of the boot comes into contact with the ground. This improves known boots, in which substantial portions of the lower surface contact the ground, causing the boot to pop-up or rotate. The disclosed improved overreach boot also advantageously relies on a lower protrusion to engage a cavity in a horse's hoof, which protrusion has a large, triangular cross-section to more securely engage with the horse's leg.

### CROSS-REFERENCE TO RELATED APPLICATION

The present application claims priority to and the benefit of U.S. Provisional Application No. 62/295,241, filed Feb. 15, 2016, the entire contents of which are incorporated by reference herein.

### BACKGROUND

A horse's hoof includes several distinct anatomical portions. Some portions of a horse's hoof are hard and, thus, are not as likely to sustain injury from minor impacts by hard objects, such as another hoof. Other portions of a horse's hoof are soft and fleshy and, as a result, are more likely to sustain injury from minor impacts by hard objects. One such example of a soft area on a horse's hoof is commonly known as the “bulb.” The bulb is a soft and fleshy area that sits above the horse's hoof on the dorsal side of the hoof. The bulb on each of a horse's front hooves is especially susceptible to injury during equestrian activities. For example, when horses perform normal equestrian activities (e.g., trotting, running, or jumping), there is a tendency for the horse's rear legs to “overreach” and, thus, strike the bulb of the front hoof. For this reason, the bulbs of a horse's front hooves are particularly susceptible to bruising, cuts, and other abrasions. Indeed, in some situations, the bulb or fleshy protrusion can be sliced completely away from the horse's leg. Such injuries can take weeks to months to heal and, depending on the severity of the injury, can affect a horse for the rest of its life. This costs horse owners not only in terms of veterinarian bills, but also in terms of lost opportunity to earn money with the injured animal.

Due to the susceptibility of a horse's front hooves to injury from overreach, the equestrian industry has long used devices commonly known as “bell boots” or “overreach boots.” Such overreach boots encircle the portions of a horse's front hooves that are likely to be struck by the horse's back hooves during an overreach. The focal points of protection, provided by overreach boots, are the bulbs of the horse's front hooves. Specifically, the primary function of an overreach boot is to protect the bulbs or fleshy protrusions on the back of the horse's front hooves at the location where each hoof wall is cleft and joins the distal pastern. The overreach boot is further designed for secure attachment to the horse's hoof during equestrian activities.

Known overreach boots, however, deliver insufficient protection to the bulbs of a horse's front hooves. Indeed, some professional equestrian riders “double-boot” their horses, in an effort to better protect the horses' bulbs during the more aggressive and athletic movements of professional-level horses. Double-booting is problematic, however, because more boot material means more weight and more restricted movement at the hoof. In the professional equestrian world, the practical result of overreach boots with more material/weight and restricted movement is slower competition times and, therefore, fewer dollars earned.

Additionally, when more material is used to create an overreach boot (or a double-boot), more surface area of the boot will likely come into contact with the ground. Increased ground contact, between the boot and the ground, increases the probability that the boot will dislodge (e.g., pop-up or rotate). When a boot dislodges, it ceases to protect the bulb during equestrian activity.

Overreach boots have traditionally been box-shaped, as dictated by tradition and ease of manufacturing. This traditional boot shape results in boots that have a tendency to dislodge, thereby leaving the bulbs unprotected. In the known traditional box-shaped designs, the named inventor believes dislodgment occurs for two reasons. First, because of the shape of the boot, too much surface area on the bottom of the overreach boot makes contact with the ground. Regardless of the type of material used to construct the interior of the boot, too much surface area on the bottom of the overreach boot, under compression, will often cause the boot to rebound or dislodge (e.g., pop-up off of the bulb and subsequently rotate). Second, in some traditional boots, a “no-turn” protrusion is used; however, such no-turn protrusions are problematic because of their positioning on the boot and their size. For example, the horse's cleft, as noted above, starts narrowly at the distal pastern and expands gradually until the cleft reaches the bottom of the hoof wall making contact with the ground. Traditional no-turn protrusions utilize only the very top, narrowest, part of the cleft to attempt to create a contact and leverage point for the overreach boot. This is an insufficient way to prevent dislodgement.

What is needed, therefore, is a lightweight overreach boot that provides maximum bulb protection with minimum restriction to the horse's movement. What is also needed is an overreach boot with an optimally designed protrusion, thus preventing boot dislodgement during use.

### SUMMARY

The overreach boot disclosed herein improves on traditional overreach boots in many ways. One object of the present disclosure is to reduce the amount of material used to make the boot. Minimizing the material means both reduced weight and reduced chances of dislodgement. In an example embodiment, the body of the overreach boot is designed to have a particular shape, and is constructed from a particular material, such that the overall weight of the overreach boot is reduced. Likewise, in an example embodiment, the overreach boot covers only the areas of a horse's limbs that need protection, and no more.

Another object of the present disclosure is to reduce the portion of the overreach boot that contacts the ground. The design of the overreach boot disclosed herein relies on a unique winged shape to minimize ground contact. As noted previously, reducing amount of ground contact results in reduced chances of dislodgement. In an example embodiment, the body of the overreach boot is optimized for minimal (if any) ground contact while the horse is moving. This reduces the tendency of the boot to dislodge (e.g., pop-up or rotate) during use. Moreover, the shape of the body of the overreach boot ensures proper positioning by keeping the boot in close contact with the pastern and hoof of the horse during use.

Yet another object of the present disclosure is to reduce the probability that the overreach boot will dislodge. The design of the overreach boot disclosed herein relies on a uniquely shaped and uniquely positioned protrusion, which resists rotation of the boot during use. Typically, horses have a lower leg anatomy in which the hoof falls away to the ground and forms a cleft in the hoof that extends from the ground up to the pastern (i.e., the ankle) of the horse. In an example embodiment, the disclosed boot includes a protrusion, referred to in various embodiments as a “no-turn” protrusion, configured to engage with the anatomy of the horse's lower leg (e.g., the cleft described above) to prevent the overreach boot from rotating during use. In a related example embodiment, this protrusion is triangular in shape.

For example, a triangular “no-turn” protrusion in embodiments of the boot disclosed herein is configured to extend into the lower portion of the horse's cleft. The triangular shape accounts for the differing anatomy and cleft lengths of horses. Further, the protrusion is positioned downward in the cleft of the horse's hoof. This allows the overreach boot to utilize a wider protrusion to fill the wider cleft in the hoof. Finally, by providing an overreach boot in which the protrusion is positioned lower into the cleft of the horse's hoof (e.g., closer to the ground), the disclosed overreach boot engages a more physiologically consistent space on the horse. Proper positioning ensures optimum friction between the overreach boot and the horse (e.g., the cleft, the hoof, the skin and hair, etc.). Each of these improvements, therefore, helps reduce the movement of the overreach boot.

In an example embodiment, an overreach boot includes a body section and a fastening section. The body section is defined by a top edge and a bottom edge. The fastening section includes a first fastening side coupled to a first end of the body section, and a second fastening side coupled to a second end of the body section. The first fastening side and the second fastening side are removably attachable to one another. A width of the body section at the first end of the body section is less than a width of the body section in a middle of the body section. Likewise, a width of the body section at the section end of the body section is less than the width of the body section in the middle of the body section.

In another example embodiment, an overreach boot includes a shaped body section. The shaped body section includes a pair of concave sides, configured to minimize contact with a ground during equine activities. The shaped body section also includes a padded protrusion, configured to engage a cleft of a front hoof. The shaped body section also includes at least one reinforced section opposite the padded protrusion, configured to deflect contact from a rear hoof corresponding to the front hoof.

In another example embodiment, a method of using an overreach boot includes positioning a body section of the overreach boot along a pastern of a hoof. The method then includes inserting a protrusion from the body section into a cleft of the hoof. The method includes wrapping a first fastening side of the overreach boot around the hoof and wrapping a second fastening side of the overreach boot around the hoof. Finally, the method includes attaching the first fastening side to the second fastening side.

Accordingly, embodiments of the disclosed overreach boot advantageously include reduced amount of material and overall size, improved shape/design, and improved protrusion positioning, to provide for a lighter and more secure overreach boot that overcomes the drawbacks of traditional overreach boots and provides superior protection without affecting equestrian activities or performance.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

FIGS. 1A-B illustrate a back view of an improved overreach boot in an unmounted, laid-flat position, next to a traditional overreach boot in an unmounted, laid-flat position.

FIG. 2 illustrates a side view of a traditional overreach boot in a mounted position, fastened around the lower leg of a horse.

FIG. 3 illustrates a side view of an improved overreach boot in a mounted position, fastened around the lower leg of a horse.

### DETAILED DESCRIPTION OF EXAMPLE EMBODIMENTS

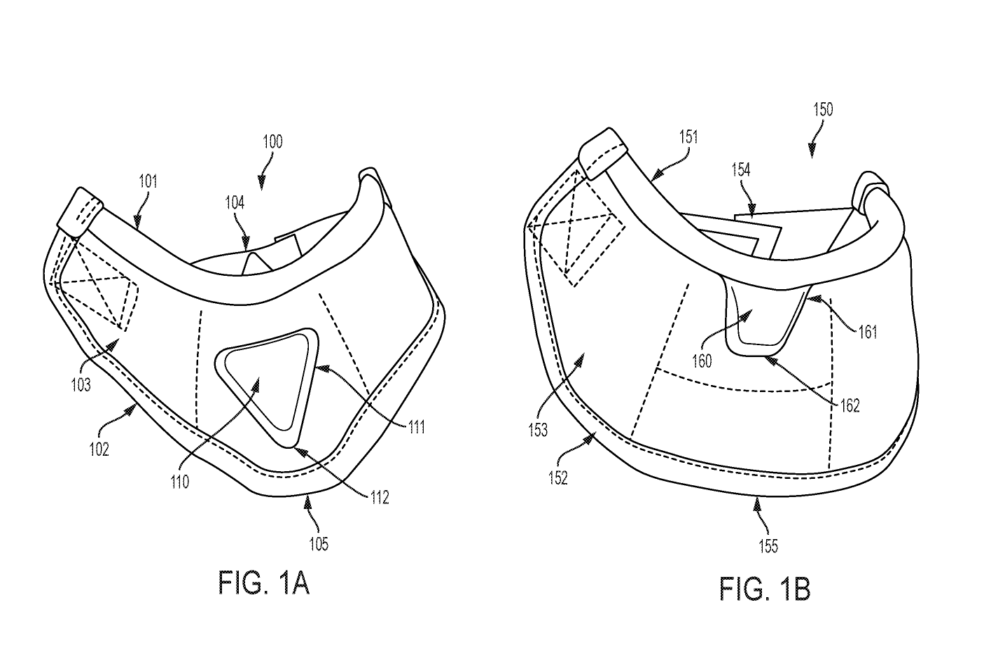

As discussed above, an improved overreach boot is provided to, among other significant advantages, reduce the amount of material and overall size of the overreach boot, reduce ground contact through improved design, and improve protrusion positioning to reduce dislodgement. FIGS. 1A-B illustrate a back view of an improved overreach boot in an unmounted, laid-flat position, next to a traditional overreach boot in an unmounted, laid-flat position.

FIG. 1A illustrates an improved overreach boot 100. Overreach boot 100 includes a top edge 101, a bottom edge 102, and a back side 103, disposed between the top edge 101 and the bottom edge 102.

In an example embodiment, the overreach boot 100, and each of the top edge 101, the bottom edge 102, and the back side 103 are constructed of a durable fabric (e.g., nylon, canvas, etc.) to provide for long-term use. In a related example embodiment, some or all of the surfaces of the overreach boot 100 are constructed of softer and/or more elastic materials (e.g., foamed neoprene, rubber, etc.) to ensure that the overreach boot 100 stretches, form-fits, etc. for a tighter and more secure mounting around the lower leg of a horse. In another related example embodiment, some or all of the surfaces of the overreach boot 100 include one or more padded portions. For example, padded portions may be constructed of ethylene-vinyl acetate (“EVA”), memory foam, gel foam, etc. to reduce overall weight of the overreach boot 100 while still providing highly resilient and comfortable contact with the lower leg of the horse. In another related example embodiment, the back side 103 includes a hard insert (e.g., a plastic or metal insert) to further protect the horse's front leg from overreach by its rear leg.

In yet another related example embodiment, the material (e.g., foam density) of the overreach boot 100 is selected for particular equine applications. For example, a heavy duty protection boot will typically include heavier protective foam. Likewise, for example, a light-weight boot (e.g., a speed boot) will typically include lighter protective foam. Both types of boots, however, will employ the same design, as described herein.

Overreach boot 100 also includes a closure mechanism 104. In various embodiments, the closure mechanism 104 may be fastened or unfastened. For example, closure mechanism 104 may include two sides, each of which are coupled to the back side 103 of the overreach boot 100. The two sides may be removably attachable to one another. When the closure mechanism 104 is fastened (e.g., the two sides are attached to one another), the overreach boot 100 forms a complete loop (e.g., around the lower leg of a horse).

In an example embodiment, the closure mechanism 104 implements hook-and-loop or similar closure technology to fasten or unfasten the closure mechanism 104. In other example embodiments, the closure mechanism 104 implements straps, belts, chains, ropes, cords and cord locks, and/or other analogous fastening technology. In an example embodiment, closure mechanism 104 is constructed of an elastic material (e.g., foamed neoprene, rubber, etc.) whereas other surfaces of the overreach boot 100 are constructed of more durable fabric (e.g., nylon, canvas, etc.).

In an example embodiment, the closure mechanism 104 implements an adjustable or tensioning mechanism (e.g., similar to cycling shoes or ski boots). In this alternate example embodiment, the closure mechanism 104 is adjustable, to tighten the overreach boot 100 as desired, depending on the anticipated forces that the overreach boot 100 will be subjected to. Additionally, an adjustable or tensioning mechanism may resist wear (e.g., loosening) over time.

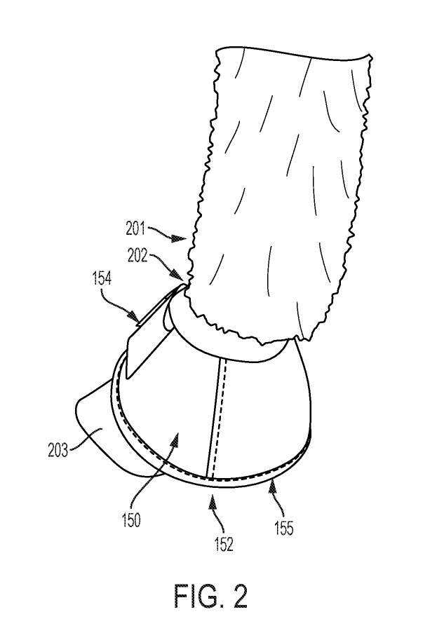

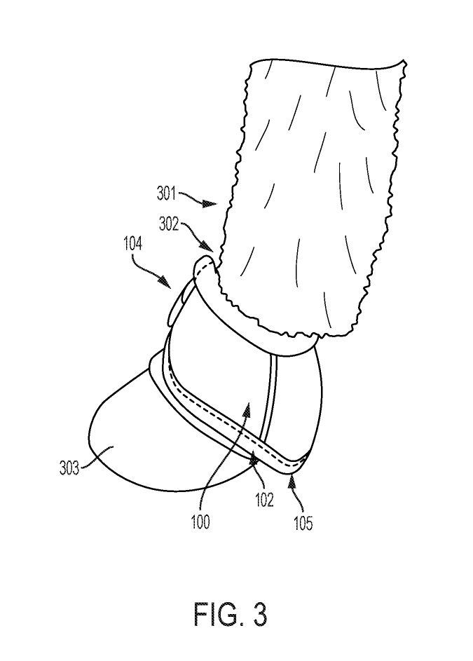

Overreach boot 100 also includes a contact point 105 along the bottom edge 102. The contact point 105 is centered along the back side 103 of the overreach boot 100, and is configured to contact the ground when the overreach boot 100 is fastened around the lower leg of a horse. In an example embodiment, the contact point 105 is configured to be a small portion of the bottom edge 102. For example, the back side 103 and the bottom edge 102 are designed in a v-shape or c-shape, such that the contact point 105 is only a small portion of the bottom edge 102 (e.g., the contact point 105 is the bottom of the v-shape or c-shape). Reducing the size of the contact point 105 that actually contacts the ground, as described with reference to FIGS. 2 and 3 herein, reduces the probability that the overreach boot 100 will dislodge (e.g., pop-up or rotate) during use. This is important, as dislodgement means that the overreach boot 100 is no longer protecting the bulb of the horse.

As noted, the contact point 105 is along the bottom edge 102 of the overreach boot 100; thus, the contact point 105 and the bottom edge 102 are more likely to come into contact with the ground than other portions of the overreach boot 100. In a related example embodiment, the contact point 105 and the bottom edge 102 are constructed of a different material (e.g., a more resilient material) than the rest of the overreach boot. This ensures that these portions, which may have higher wear and fatigue, due to contact with the ground, are more durable.

Overreach boot 100 also includes a protrusion 110. Protrusion 110 is positioned on the back side 103 of the overreach boot 100. Protrusion 110 includes a top side 111 and a bottom side 112. Protrusion 110 is configured to engage with the anatomy of the horse's lower leg. For example, the protrusion 110 engages with a cleft in the horse's hoof that extends from the ground up to the pastern (i.e., the ankle) of the horse. By engaging with the cleft in the horse's hoof, protrusion 110 prevents the overreach boot 100 from dislodging. In an example embodiment, the protrusion 110 is constructed of gel or gel-foam.

In an example embodiment, protrusion 110 is triangular in shape. For example, a triangular shape accounts for differing anatomy and cleft lengths of various horses. In a related example embodiment, protrusion 110 is positioned downward in the cleft of the horse's hoof. For example, the triangular shape points downward, towards the ground, such that the top side 111 of the protrusion is wider than the bottom side 112 of the protrusion. In a related example, the bottom side 112 of the protrusion 110 is a point. This configuration ensures the overreach boot 100 implements a wider protrusion to fill the wider cleft towards the top of the hoof (e.g., at the top side 111 of the protrusion). In another example embodiment, protrusion 110 is positioned lower on the back side 103 of the overreach boot 100 (e.g., closer to the bottom edge 102 than the top edge 101). By positioning the protrusion 110 lower, the protrusion 110 engages a lower portion of the cleft of the horse's hoof, which is a more physiologically consistent space on the horse, thus ensuring a proper engagement to prevent the overreach boot 100 from dislodging.

By comparison, FIG. 1B illustrates a traditional overreach boot 150. Overreach boot 150 includes a top edge 151 and a bottom edge 152. Overreach boot 150 includes a back side 153, disposed between the top edge 151 and the bottom edge 152. Overreach boot 150 also includes a closure mechanism 154. The overreach boot 150 also includes a contact point 155 along the bottom edge 152. The contact point is centered along the back side 153 of the overreach boot 150. Overreach boot 150 also includes a protrusion 160. Protrusion 160 is positioned on the back side 153 of the overreach boot 150. Protrusion 160 includes a top side 161 and a bottom side 162.

Comparing the improved overreach boot 100 with the traditional overreach boot 150, the features of the improved overreach boot 100 are apparent. More specifically, for example, FIGS. 1A-B illustrate the difference in the size and shape of the improved overreach boot 100. The improved overreach boot 100 has a v-shape or a c-shape design. More specifically, for example, the back side 103, the top edge 101, and the bottom edge 102 define a v-shape or a c-shape profile. In a flat configuration, as shown by FIG. 1A, it is readily apparent that the improved overreach boot 100 uses a reduced amount of material.

By comparison, the traditional overreach boot 150 has a u-shape or a boxed-shape design. More specifically, for example, the back side 153, the top edge 151, and the bottom edge 152 define a u-shape or a boxed-shape profile. In a flat configuration, as shown by FIG. 1B, it is readily apparent that the traditional overreach boot 150 uses more material, when compared to the improved overreach boot 100.

Using less material, through the newly designed profile, reduces the total weight of the improved overreach boot 100. Reduced weight means that the horse will be less encumbered when wearing the improved overreach boot 100 (e.g., less stress on the animal, improved competition times, etc.). Moreover, the improved overreach boot 100 covers only the areas of a horse's limb that need protection (e.g., the horse's bulb), and no more.

FIGS. 1A-B also illustrate a reduction in ground contact, as achieved by the improved overreach boot 100. The improved overreach boot 100 has the contact point 105, along the bottom edge 102 and centered along the back side 103. The contact point 105 is configured to contact the ground, and is also configured to be a small portion of the bottom edge 102. For example, with the v-shape or c-shape profile of the improved overreach boot 100, the contact point 105 is only a small portion of the bottom edge 102 (e.g., the contact point 105 is the bottom of the v-shape or c-shape). In an example embodiment, this small contact point 105 is the only part of the improved overreach boot 100 that touches the ground.

By comparison, the traditional overreach boot 150 has a contact point 155, along the bottom edge 152 and centered along the back side 153. The contact point 155 is configured to contact the ground, but is configured to be a substantial portion of the bottom edge 152. For example, with the u-shape or boxed-shape profile of the traditional overreach boot 150, the contact point 155 is a significant portion of the bottom edge 152 (e.g., the contact point 155 is most, if not all, of the bottom edge 152).

Reducing the size of contact point 105 reduces the probability that the overreach boot 100 will come into contact with the ground and subsequently dislodge (e.g., pop-up or rotate) during use. For example, when the hoof of the horse strikes the ground, the force of the hoof is generally directed downward. In response, a normal force from the ground is generally directed upward. To the extent that any part of the overreach boot 100 is touching the ground, the overreach boot 100 will experience at least a portion of this normal force. From a design perspective, one would prefer to avoid boot-to-ground contact. Thus, reducing the size of the contact point 105 reduces the chances that the contact point 105 will actually strike the ground and related ground features (e.g., uneven surfaces on the ground, sticks, rocks, etc.), which may lead to dislodgement. By comparison, the increased surface area of the traditional overreach boot 150 and related contact point 155 ensures that the contact point 155 has a greater chance of striking the ground and related ground features. Increased size of the contact point 155, thus, increases the probability that the overreach boot 150 will dislodge (e.g., pop-up or rotate). This phenomenon is further described with reference to FIGS. 2 and 3 herein.

FIGS. 1A-B also illustrate the protrusion positioning on the improved overreach boot 100. The improved overreach boot 100 has protrusion 110, which is larger, is triangular-shaped pointing downward (e.g., wider at the top and pointed at the bottom), and is positioned lower (e.g., closer to the ground) on the back side 103. By comparison, the traditional overreach boot 150 has protrusion 160, which is smaller, is not wide at the top and pointed at the bottom, and is positioned higher (e.g., further from the ground) on the back side 153.

Having a larger protrusion 110 ensures that the protrusion 110 engages more of the cleft of the horse's leg. Increased cleft-engagement ensures a more secure fit, thus preventing dislodgement of the improved overreach boot 110. Likewise, having a triangular-shaped (e.g., wider at the top) protrusion 110 pointing downward, and having a lower protrusion 110 (e.g., closer to the ground), both ensure proper cleft-engagement. A wider protrusion 110 that has been dropped lower toward the ground takes advantage of the naturally larger cavity on a horse's leg (e.g., the cleft that is expanding away from the distal pastern). In short, this means that more of the protrusion 110 makes contact with the hoof, thereby increasing the friction between the improved overreach boot 100 and the hoof and decreasing the probability that the overreach boot 100 will dislodge.

In an example embodiment, the improved overreach boot 100 includes particular color schemes. For example, in various embodiments, the colors of the top edge 101, the bottom edge 102, the back side 103, the closure mechanism 104, and the protrusion 105 may be the same and/or different. By implementing various color schemes, the improved overreach boot 100 can readily indicate, to a user, whether the boot is a particular size, is made of a particular material, includes particular features (e.g., a hard insert on the back side 103), is intended for a particular leg (e.g., left or right), is intended for a particular animal (e.g., grown-horse or colt) etc.

FIG. 2 illustrates a side view of the traditional overreach boot in a mounted position, fastened around the lower leg of a horse. The traditional overreach boot 150 is fastened to a horse's leg 201, between the pastern 202 (i.e., the ankle) and the hoof 203. The hoof 203 is in contact with the ground.

As illustrated, a significant portion of the traditional overreach boot 150 is in contact with the ground. For example, it appears that most of the bottom edge 152 and all of the contact point 155 are in contact with the ground. As noted previously, ground contact is undesirable and may lead to dislodgement of the traditional overreach boot 150 during use. Moreover, the traditional overreach boot 150 has excessive material (e.g., along the sides and front of the hoof 203), which may encumber the horse.

FIG. 3 illustrates a side view of the improved overreach boot in a mounted position, fastened around the lower leg of a horse. The improved overreach boot 100 is fastened to a horse's leg 301, between the pastern 302 (i.e., the ankle) and the hoof 303. The hoof 303 is in contact with the ground.

As illustrated, very little, if any, of the improved overreach boot 100 is in contact with the ground. For example, it appears that none of the bottom edge 102 and almost none (if any) of the contact point 105 are in contact with the ground. As noted previously, ground contact is undesirable. By avoiding ground contact, the improved overreach boot 100 reduces the probability of dislodgement during use. Moreover, the improved overreach boot 100 has reduced material (e.g., there is no material covering the sides and front of the hoof 303), which ensures that the improved overreach boot 100 is lighter.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

The invention is claimed as follows:

1. An overreach boot comprising:
a body section, the body section defined by a top edge and a bottom edge; and
a fastening section, the fastening section including:
a first fastening side coupled to a first end of the body section, and
a second fastening side coupled to a second end of the body section,
wherein the first fastening side and the second fastening side are removably attachable to one another,
wherein a width of the body section at the first end of the body section is less than a width of the body section in a middle of the body section, and
wherein a width of the body section at the section end of the body section is less than the width of the body section in the middle of the body section.

2. The overreach boot of claim 1, wherein the body section includes a protrusion, the protrusion configured to engage with a hoof.

3. The overreach boot of claim 2, wherein the protrusion is wider at a top side of the protrusion and narrower at a bottom side of the protrusion.

4. The overreach boot of claim 2, wherein the protrusion is positioned closer to the bottom edge of the body section than the top edge of the body section.

5. The overreach boot of claim 2, wherein a reinforced section is positioned opposite the protrusion.

6. The overreach boot of claim 2, wherein the protrusion is a padded protrusion.

7. The overreach boot of claim 1, wherein the body section is one of c-shaped and v-shaped.

8. The overreach boot of claim 1, wherein the body section is configured to have minimum contact with the ground when the overreach boot engages with a hoof.

9. The overreach boot of claim 1, wherein the first fastening side is removably attachable to the second fastening side via an adjustable closure mechanism.

10. The overreach boot of claim 9, wherein the adjustable closure mechanism is one of hook-and-loop, strap, belt, chain, rope, or cord and cord lock.

11. The overreach boot of claim 9, wherein the adjustable closure mechanism is an adjustable tensioning mechanism.

12. An overreach boot comprising:
a shaped body section having:
a pair of concave sides configured to minimize contact with a ground during equine activities,
a padded protrusion, configured to engage a cleft of a front hoof, and
at least one reinforced section opposite the padded protrusion, configured to deflect contact from a rear hoof corresponding to the front hoof.

13. The overreach boot of claim 12, wherein the padded protrusion is wider at a top side of the protrusion and narrower at a bottom side of the protrusion.

14. The overreach boot of claim 12, wherein the padded protrusion is positioned closer to a bottom edge of the shaped body than a top edge of the shaped body.

15. The overreach boot of claim 12, wherein the shaped body section is one of c-shaped and v-shaped.

16. The overreach boot of claim 12, further comprising a fastening section, the fastening section including:
a first fastening side, coupled to a first end of the shaped body section, and
a second fastening side, coupled to a second end of the shaped body section,
wherein the first fastening side and the second fastening side are removably attachable to one another.

17. The overreach boot of claim 16, wherein the first fastening side is removably attachable to the second fastening side via an adjustable closure mechanism.

18. The overreach boot of claim 17, wherein the adjustable closure mechanism is one of hook-and-loop, strap, belt, chain, rope, or cord and cord lock.

19. The overreach boot of claim 17, wherein the adjustable closure mechanism is an adjustable tensioning mechanism.

20. A method of using an overreach boot, the method comprising:
positioning a body section of the overreach boot along a pastern of a hoof;
inserting a protrusion from the body section into a cleft of the hoof;
wrapping a first fastening side of the overreach boot around the hoof;
wrapping a second fastening side of the overreach boot around the hoof; and
attaching the first fastening side to the second fastening side.
